(19) United States
(12) Patent Application Publication
(10) Pub. No.: US 2013/0118074 A1
(43) Pub. Date: May 16, 2013

(54) HYDROPONIC MODULAR PLANTING SYSTEM

(71) Applicant: Steven FULBROOK, Canmore (CA)

(72) Inventor: Steven FULBROOK, Canmore (CA)

(21) Appl. No.: 13/673,100

(22) Filed: Nov. 9, 2012

Related U.S. Application Data
(60) Provisional application No. 61/558,228, filed on Nov. 10, 2011.

(51) Int. Cl. A01G 31/06

(52) U.S. Cl. 47/62 N; 47/59 R

(57) ABSTRACT

A hydroponic modular planting system includes individual growing modules, each having a combined growing chamber and plant supporting surface for growing plants hydroponically using a nutrient-rich solution. The individual growing modules can be stacked vertically and/or laterally to form a modular planting system built from any number of individual growing modules. The modular planting system can be formed into a large number of possible shapes and sizes and can therefore be conformed to a variety of growing environments.

### CROSS REFERENCE TO RELATED APPLICATIONS

This application claims the benefit of U.S. Provisional Application Ser. No. 61/558,228, filed Nov. 10, 2011, entitled “Modular Planting System,” the entire disclosure of which is incorporated herein by reference.

### FIELD OF THE INVENTION

The present invention is directed to a hydroponic modular planting system comprising individual growing modules, each having a combined growing chamber and plant supporting surface for growing plants hydroponically using a nutrient-rich solution. The individual growing modules can be stacked vertically and/or laterally to form a modular planting system built from any number of individual growing modules. The modular planting system can be formed into a large number of possible shapes and sizes and can therefore be conformed to a variety of growing environments.

### BACKGROUND OF THE INVENTION

Hydroponics is a well known method used to grow plants using aqueous nutrient solutions without the use of soil. The plants can be grown solely in water with their roots suspended either in the nutrient solution, in the air with the nutrient solution cascading among them, or by using a growing medium to support the roots during growth while ensuring contact with the nutrient solution. The growing medium can be either man-made or organic and can include various materials such as perlite, gravel, mineral wool, coconut husk, vermiculite, clay pellets, sand, moss, insulation, saw dust, lava rock and the like. Generally, the type of medium selected may be based on the amount of aeration and draining required for the plant during growth. The nutrient solution is typically circulated in order to maintain continuous or regular flow of the nutrient solution to the plant roots and thereby contribute to optimal growing conditions for the plants.

There are distinct advantages to using hydroponics to grow plants in various applications. First, the water remains in the system as it is circulated; as opposed to a continual need to add water as is the case with soil planting, which can lead to substantial production cost savings in certain conditions. In addition, the nutrition levels can be tailored to give a high degree of control to the grower which can also lead to lower overall production costs. The yields of the plants can be higher and more stable compared to soil-planted plants and importantly the plants can be grown in areas where in-ground gardening or agriculture is not possible. Furthermore, diseases can often be more readily treated or addressed due to the ease of plant removal and washing.

The two main growing methods utilizing hydroponics are the solution culture method and the medium culture method. In the solution culture method, only the solution containing the nutrients is used for growing the plants and no solid medium is employed. The medium culture method uses a solid medium for the roots to provide support and assist with nutrient delivery. There are also two types of growing culture based on whether the water is static or flowing. In a static solution culture, the plants are grown in containers and may be aerated or un-aerated. In continuous flow culture, the nutrient solution is continuously passed through and around the roots of the plant.

As noted above, there are a number of medium types that can be used to support the roots and assist in the delivery of both oxygen and nutrients to the roots. One of the more popular forms of medium is expanded clay wherein baked clay pellets are effective in controlling nutrient delivery to the roots. The clay pellets are generally porous, allowing oxygen and nutrient water to exist within and around the pellets to help aerate the plants. Rock wool is another popular medium and is generally characterised as an inert substrate typically made from molten rock and spun into bundles of single filament fibres. Rock wool is also known to be resistant to most microbiological degradation which can provide certain advantages.

Coir or coco peat derived from the coconut can also be used as a medium material in hydroponics and is known to protect roots and stimulate root growth. Another medium is perlite which is superheated volcanic rock that has been expanded into glass pellets and is often selected to decrease soil density. Pumice is similar to perlite, and is a lightweight volcanic rock that is also an effective hydroponic medium. Vermiculite can also be used and is a mineral that has been superheated resulting in small expanded pellets that are useful for hydroponics. Others include sand, gravel, brick shards and wood fibre.

Nutrient solutions are typically aqueous solutions containing inorganic and ionic species. Characteristic dissolved cations include calcium Ca²⁺, magnesium Mg²⁺, and potassium K⁺ while the typical anions include nitrate NO₃⁻, sulphate SO₄²⁻and dihydrogen phosphate H₂PO₄⁻. Compounds typically used to deliver the nutrients include potassium nitrate, calcium nitrate, potassium phosphate and magnesium sulphate. Essential micro-elements can also be added to the nutrient solutions in hydroponics and may include iron, manganese, copper, zinc, boron, chlorine, and nickel.

As noted above, a key advantage to using hydroponics is space saving. Hydroponic growing can take place in small containers requiring a small volume compared to the generally large amount of volume usually needed for soil-based agriculture. In other words, due to the continual delivery of nutrients to the roots in hydroponics, the amount of volume/area required is minimized.

A number of hydroponic planting apparatus have been developed that hold plants in place, while suspending their roots either directly in the nutrient solution or in a suitable medium. A brief discussion of the relevant prior art follows.

U.S. Pat. No. 6,477,805 to Ware is an example of a conventional vertical hydroponic system. Ware teaches a plant growth unit including a nutrient supply module with one or more columns radially disposed about a central axis. The columns include a plurality of growth sites. U.S. Pat. No. 4,255,896 to Carl teaches a hydroponic apparatus composed of a series of tubes that support a plurality of plants maintained in individual planting cups. Slot-like apertures permit the roots of the plant to extend within the tubes. Sterile liquid is isolated from the direct flow of the nutrient fluid. U.S. Pat. No. 7,080,482 to Bradley teaches a modular plant growing apparatus utilizing a nutrient solution reservoir and a plant supporting structure comprising inner and outer walls. A pumping system delivers the nutrients to the plants within the structure.

Despite the availability of a wide variety of hydroponic planting units, there remains a need for users to be able to adjust the size of the hydroponic system to suit a variety of space limitations and planting requirements. That is, many of the systems available are sold as single units without the ability to adjust the size of the system (i.e. the number of individual planting units within the system). As in the cases discussed above, and in particular with respect to Bradley, the available systems either lack modularity or have a relatively large number of planting units within an individual module. The smallest subunit of the planting apparatus disclosed in the prior art is restricted to multiple planting sites within a single subunit and does not permit a high level of modularity that can be adapted to a variety of environments and user needs. This limits the planting system in the degree to which it can be varied and the type of space it can be used within. For example, a person living in the city with limited growing space, such as in an apartment building, may want to hang a hydroponics system from their balcony. Another individual may wish to hang a single vertical row of plants or a single lateral row of plants. Moreover, the use of hydroponic systems in or around angled spaces such as the corner of a room or building, against an interior wall, or around a specific piece of furniture may be required. In addition, transport of pre-sized systems may be cumbersome if such spaces are of an awkward shape and/or size.

As such, there is a need for a planting system that allows for each module to contain a low number of plants, and that allows for the greatest degree of control over planting system size, thus effectively addressing the issues discussed above.

### SUMMARY OF THE INVENTION

A modular planting system is described having individual growing modules for hydroponic plant growth.

In accordance with a first embodiment of the invention, a growing module for growing plants hydroponically is provided, the growing module comprising: a growing chamber having a first growing chamber end and a second growing chamber end, the growing chamber defining a first inner volume, the first growing chamber end having a first opening to the first inner volume, and the second growing chamber end having a second opening to the first inner volume; a plant supporting surface extending outwardly from the growing chamber, the plant supporting surface defining a second inner volume interconnected with the first inner volume for supporting a plant within both the first and second inner volumes; and the first growing chamber end and second growing chamber end having connection means for interconnecting a plurality of growing modules.

In another embodiment, the plant supporting surface includes supports for engagement with a container fitted within the second inner volume, the container for supporting planting medium.

In other embodiments, the plant supporting surface is flexibly coupled to the growing chamber for either disposing the plant supporting surface within the first inner volume, or extending the plant supporting surface outwardly from the growing module.

In yet another embodiment, the growing chamber includes lateral connectors integrated with the growing chamber, enabling lateral coupling of the growing module to at least one adjacent growing module.

In one embodiment the growing chamber includes a collection funnel for connecting the second growing chamber end to a nutrient collection system.

In another embodiment, the system includes a removable cap for coupling to the first growing chamber end.

In another embodiment, the connection means includes securing lips for rotatable engagement with the second growing chamber end of an adjacent growing module. The connection means can include snaps for frictional engagement with the second growing chamber end of an adjacent growing module.

In another embodiment, the growing module includes a flow restriction device within the first volume for restricting the flow of nutrient water from the first volume.

In another embodiment, the growing chamber includes at least two plant supporting surfaces integrated to the growing chamber.

In another aspect, the invention provides a growing module kit for growing plants hydroponically comprising: at least one growing chamber, the at least one growing chamber having a first growing chamber end and a second growing chamber end, the at least one growing chamber defining a first inner volume, the first growing chamber end having a first opening to the first inner volume, and the second growing chamber end having a second opening to the first inner volume; at least one plant supporting surface extending outwardly from the at least one growing chamber, the at least one plant supporting surface defining a second inner volume interconnected with the first inner volume for supporting a plant within both the first and second inner volumes; and the first growing chamber end and second growing chamber end having connection means for interconnecting a plurality of growing modules; at least one collection funnel for connecting a second growing chamber end to a nutrient collection system; and, at least one removable cap for coupling to a first growing chamber end.

### BRIEF DESCRIPTION OF THE DRAWINGS

The invention is described with reference to the drawings in which:

FIG. 1 is an elevational front view of one embodiment of the invention showing a growing module in a planting position.

FIG. 2 is an elevational side view of one embodiment of the invention showing a growing module in a planting position.

FIG. 3 is an elevational rear view of one embodiment of the invention showing a growing module in a planting position.

FIG. 4 is a right side perspective view of one embodiment of the invention showing a growing module in a planting position.

FIG. 5 is a bottom perspective view of one embodiment of the invention showing a connector.

FIG. 6 is a top perspective view of one embodiment of the invention showing a growing module.

FIG. 7 is a top view of one embodiment of the invention showing an interior of a growing chamber.

FIG. 8 is an isometric view of a growing module showing a cap in accordance with one embodiment of the invention.

FIG. 9 is an isometric view of a growing module showing a dripper in accordance with one embodiment of the invention.

FIG. 10 is a front perspective view of the invention showing a modular planting system in a vertically stacked configuration.

FIG. 11A is a front view of the invention showing a modular planting system in a vertically stacked configuration.

FIG. 11B is a rear view of the invention showing a modular planting system in a vertically stacked configuration.

FIG. 12 is a side view of the invention showing a modular planting system in a vertically stacked configuration.

FIG. 13 is a schematic front view of one embodiment of the invention showing a modular planting system in a vertical and horizontal stacked configuration.

FIG. 14A is a side view of one embodiment of the invention showing a growing module in a planting position.

FIG. 14B is a side view of one embodiment of the invention showing a growing module in a collapsed position.

FIG. 15 is a side view of one embodiment of the invention showing a growing module in a planting position.

FIG. 16 is a side view of one embodiment of the invention showing a side connector.

### DETAILED DESCRIPTION OF THE INVENTION

As shown in the figures, the invention generally relates to a modular planting system comprising individual and growing modules 10 for growing plants using hydroponics. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

In accordance with the invention, there is generally provided a modular planting system comprising individual growing modules 10 that include a growing chamber 12 having first and second ends, 16 and 18, and a plant supporting surface 14 having first and second ends, 20 and 22. The growing chamber 12 defines a first inner volume for housing the lower portion of a plant (i.e. roots), and any nutrient water passing through the apparatus. The plant supporting surface 14 defines a second inner volume for housing the upper portion of the plant bearing the stems, leaves etc. and allows the upper portion of the plant to grow upwardly. The growing chamber 12 is coupled to the plant supporting surface 14 such that the first and second inner volumes are in direct contact with each other. The first end 16 of the growing chamber 12 includes a first opening 16a into the first inner volume. The second end 18 of the growing chamber 12 includes a second opening 18a into the first inner volume. The individual growing modules 10 are capable of being used independently or stacked to form a modular planting system of any desired size for planting any number of plants.

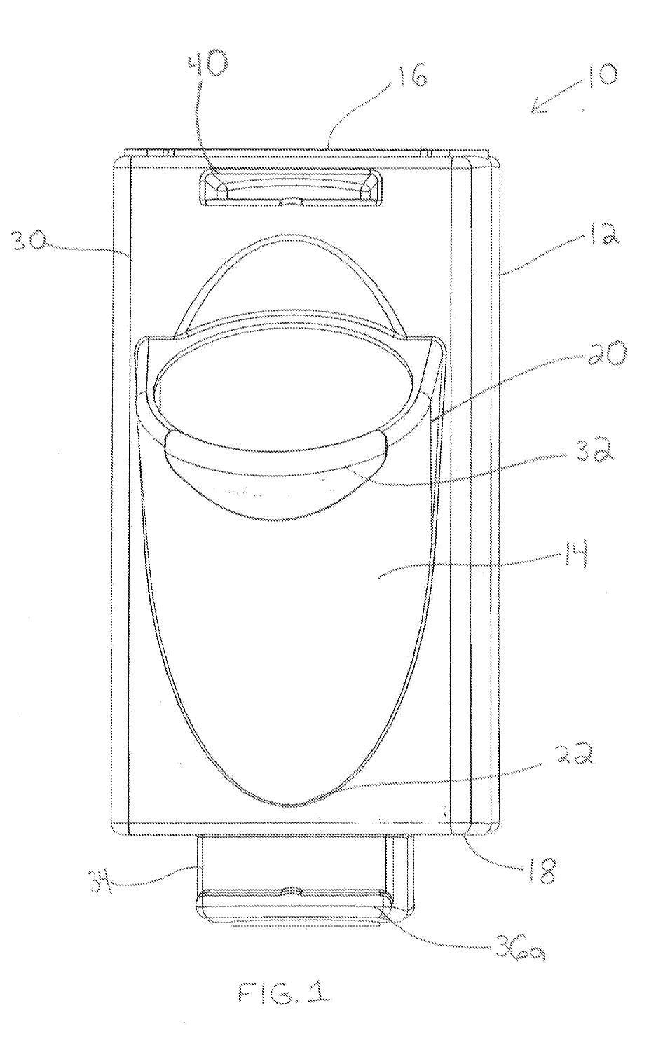

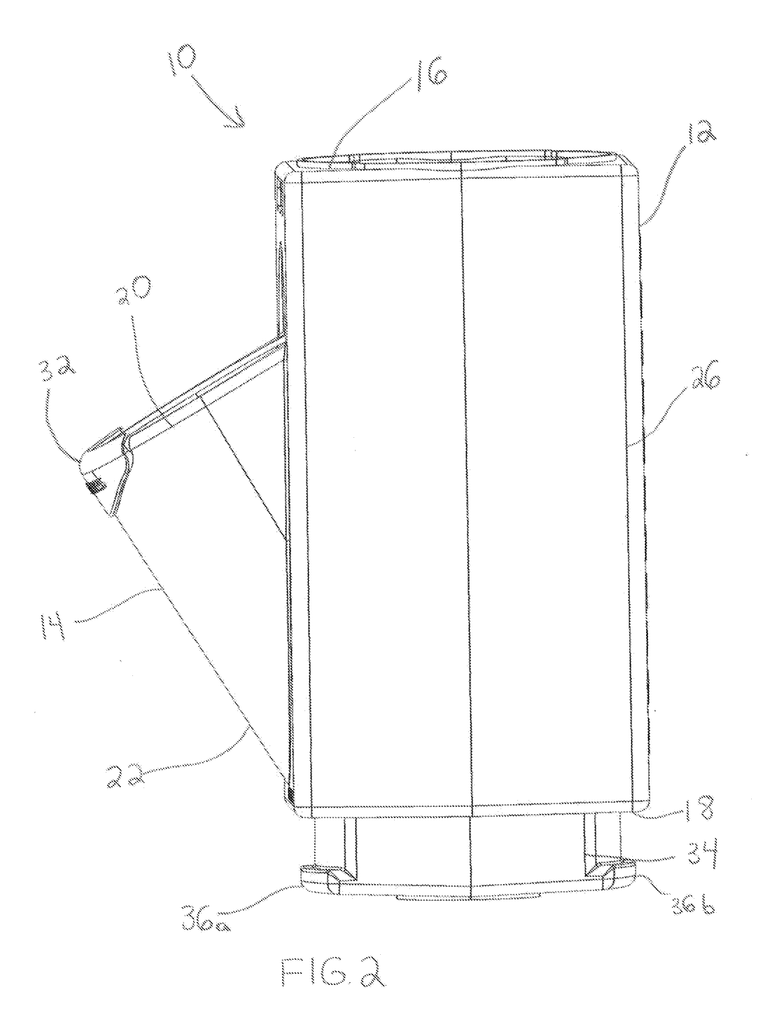

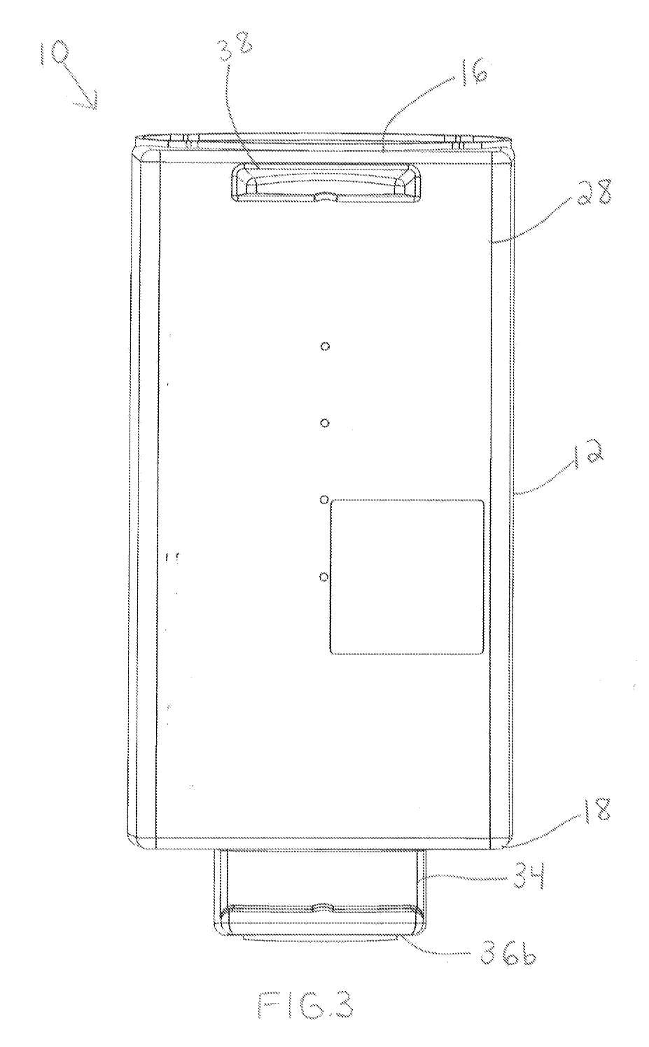

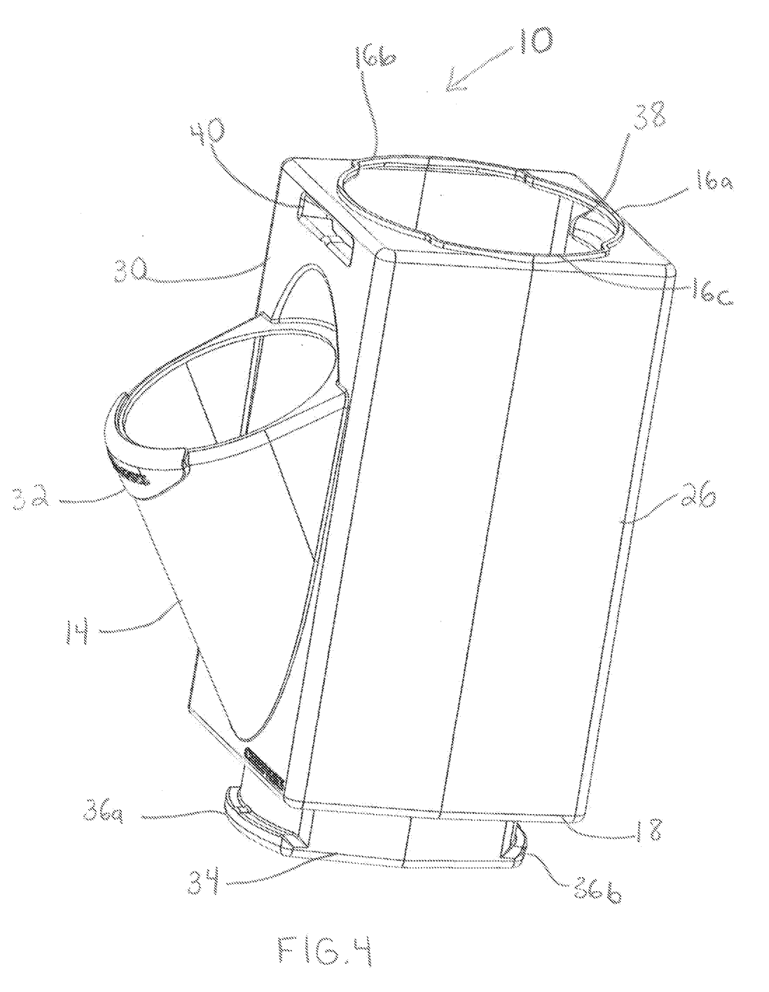

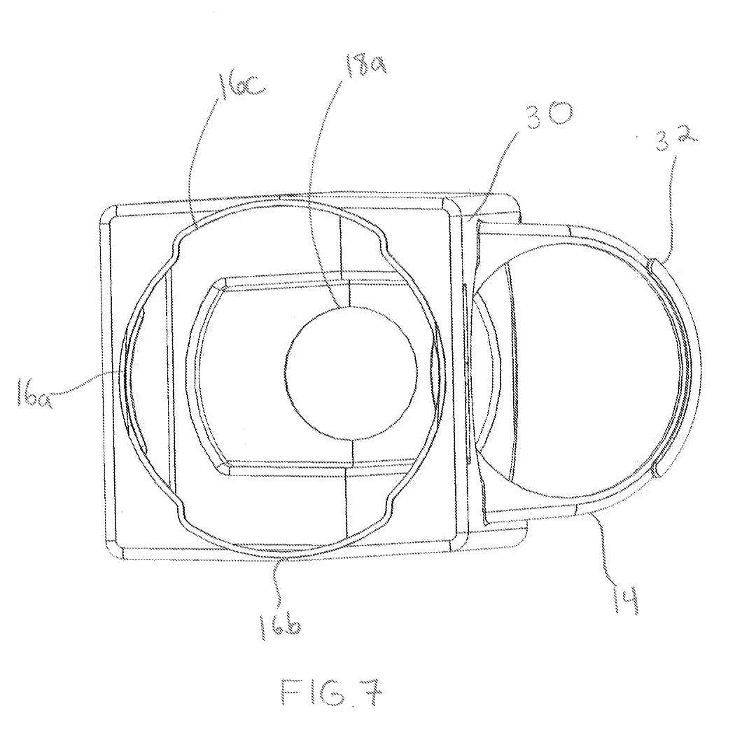

In one embodiment of the invention, and for the purposes of description herein, the growing chamber 12 is a rectangular form having three flat sidewalls consisting of a left sidewall 24, a right sidewall 26, and a rear sidewall 28, in addition to a front panel 30 as best shown in FIGS. 1-7. The plant supporting surface 14 is a generally rounded surface extending from the growing chamber 12 to provide support for the plant and provide an opening for the plant to extend outwardly from. As shown in FIG. 4, the plant supporting surface 14 can include a protective lip 32 at the first end.

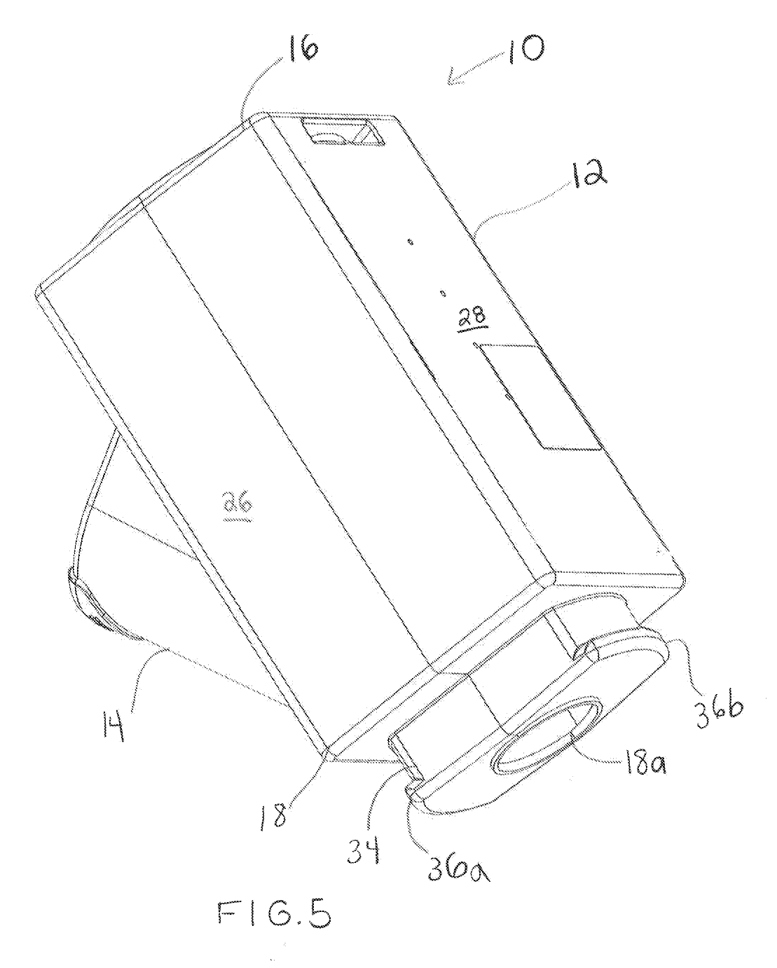

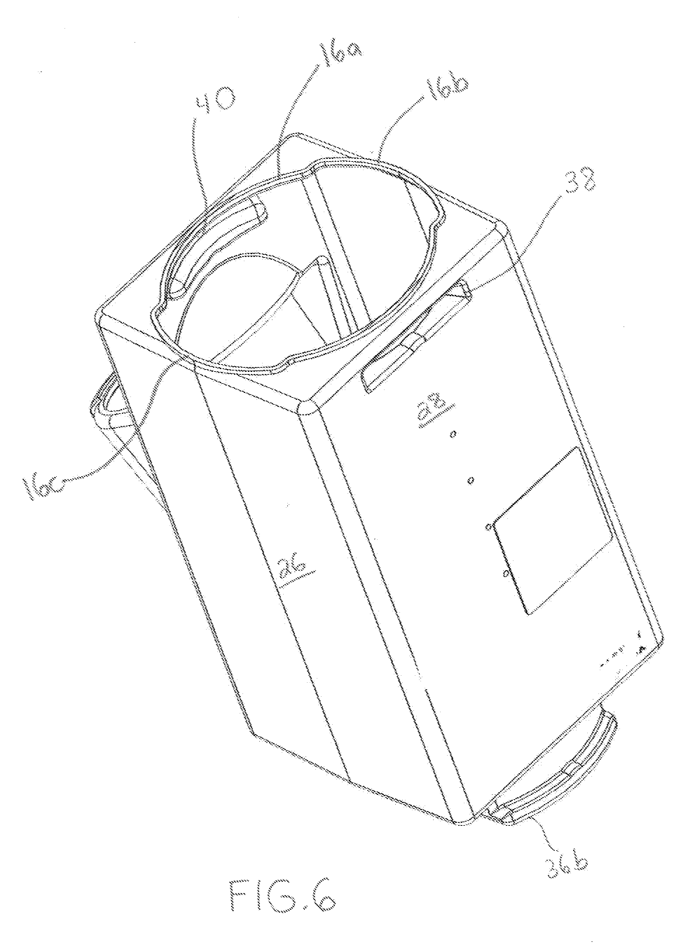

Referring to FIGS. 5 and 6, at the second end 18 of the growing chamber 12 there is provided a connector 34 including securing lips 36a, 36b on the front and rear sides of the connector. At the first end (upper) 16 of the growing chamber 12, the first opening 16a is generally round with a first and second indent 16b, 16c in the right and left side of the opening. The first end 16 also includes first and second detents, 38 and 40, on the rear wall 24 and front panel 30 respectively. The structure of the connector 34, the first opening 16a and the first end 16 allow growing modules to be vertically coupled to one another by a “insert and twist” movement. Specifically, to couple the bottom of a first growing module to the top of a second growing module, the connector 34 of the first growing module is inserted into the first opening 16a of the second growing module, with the securing lips 36a, 36b of the first growing module lined up with the first and second indent 16b, 16c of the second growing module. By lining the growing modules up in such a manner that the rear sidewall 28 of the first growing module is offset 90° to the rear sidewall 28 of the second growing module, the connector 34 of the first growing module can fit through and be completely inserted into the first opening 16a of the second growing module. Upon insertion, the first and second growing modules are twisted 90° around a vertical axis in either direction with respect to one other such that the rear sidewalls 28 of both growing modules are lined up and the securing lips 36a, 36b of the first growing module engage with the first and second detents 38, 40 of the second growing module, effectively coupling the first and second module together.

To disengage the first growing module from the second growing module, the modules are twisted 90° around a vertical axis in either direction with respect to one another. This movement disengages the securing lips 36a, 36b from the first and second detents 38, 40 and allows the connector of the first growing module to be removed from the first opening 16a of the second growing module.

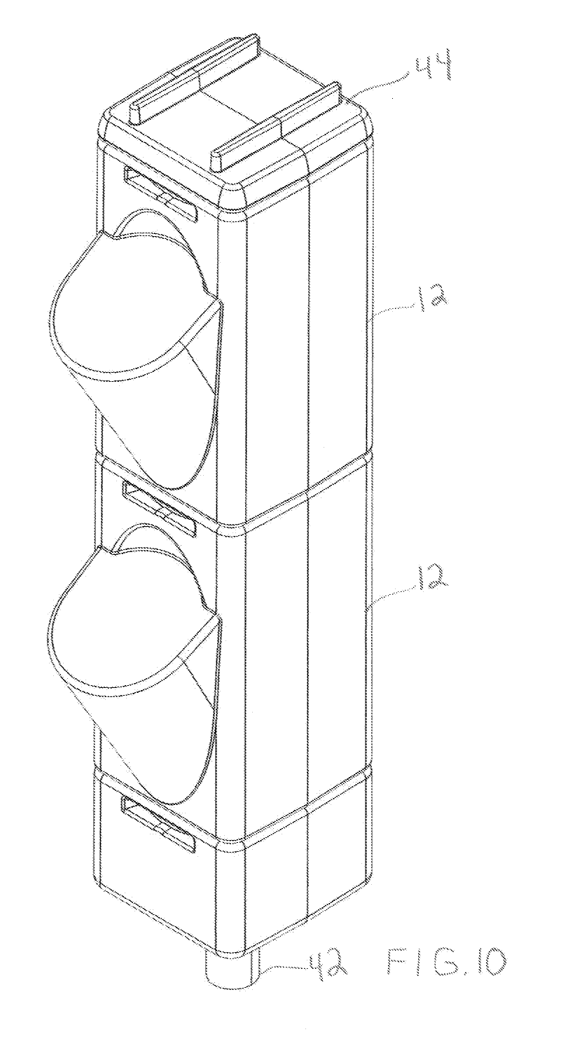

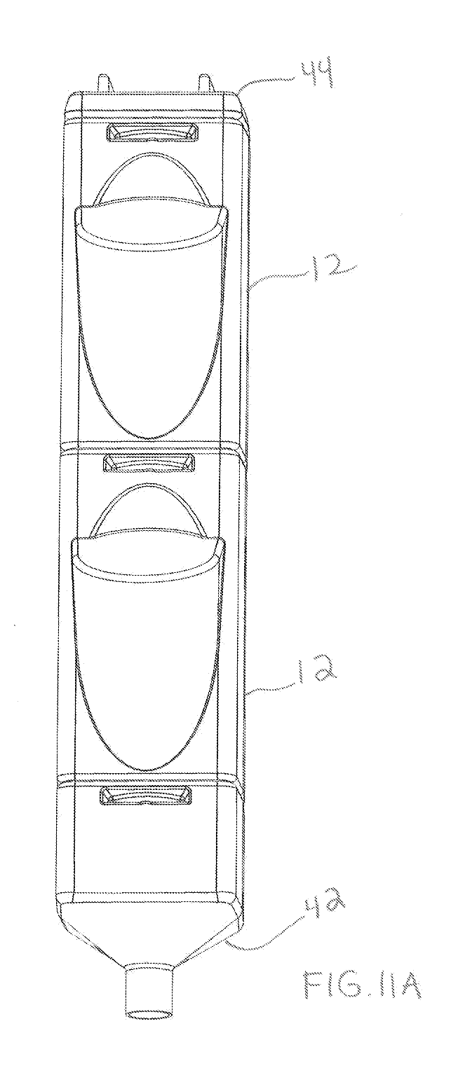

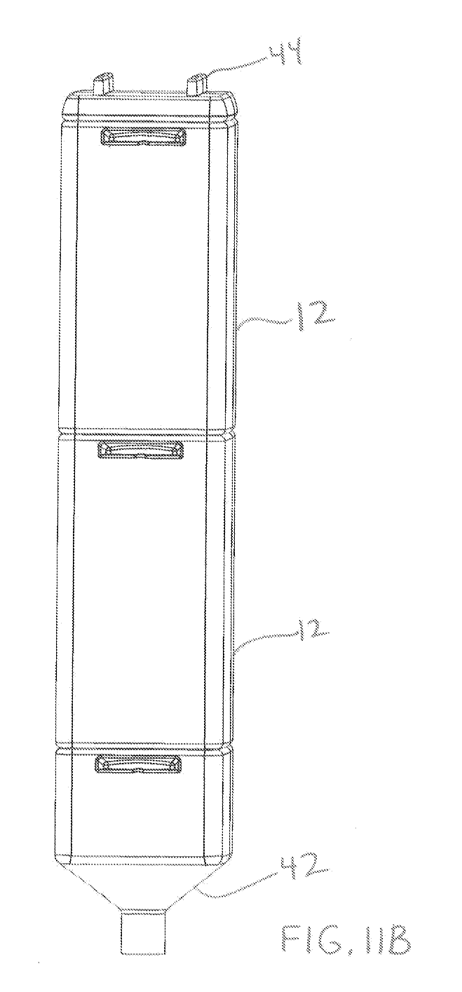

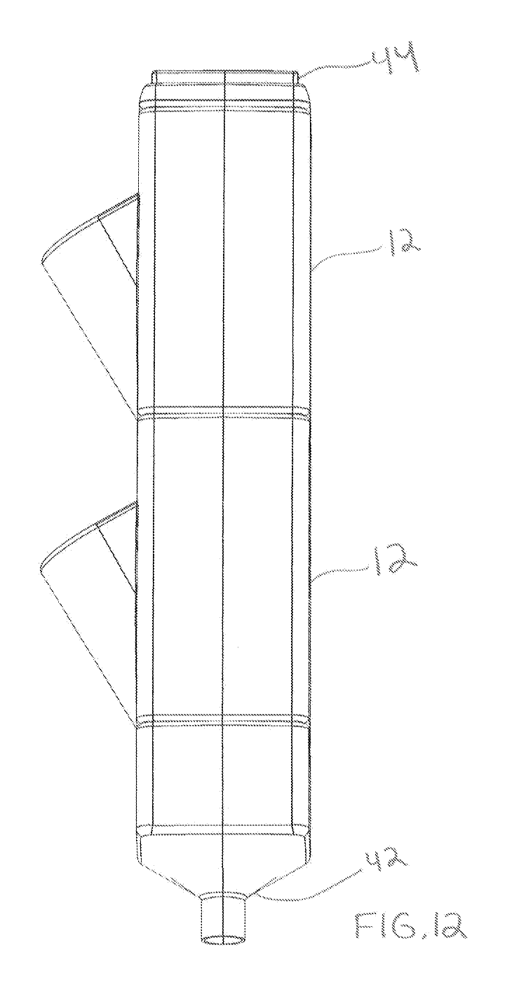

The ability of the growing modules to engage with each other forms a modular planting system including at least two individual growing modules, as shown in FIGS. 10-12. The insert and twist interconnection can be extended to any number of individual growing modules 10 to form an interconnected series of growing modules. As shown in FIG. 13 and described in greater detail below, 16 growing modules have been interconnected to form four separate assemblies of interconnected modules.

Once assembled, nutrient solution is introduced to the system and enters at the first end 16 of the top most growing module 10 via feed lines 58 (FIG. 13).The feed lines receive nutrient solution from a water hose 60 ultimately connected to a holding tank 50 containing the nutrient solution. As the nutrient solution enters the first end 16 of the top most growing module 10, it cascades down and through the first inner volume of the growing module and comes into contact with the roots of the plant that are suspended either with or without a planting medium. In various embodiments, it may be desired to control the flow of nutrient solution through each module and, thus, each module may be provided with a disk (not shown) that may be seated within each module so as to restrict the flow of nutrient solution. That is, a disk may reduce the flow of nutrient solution such that nutrient solution may pool within the lower regions of each module.

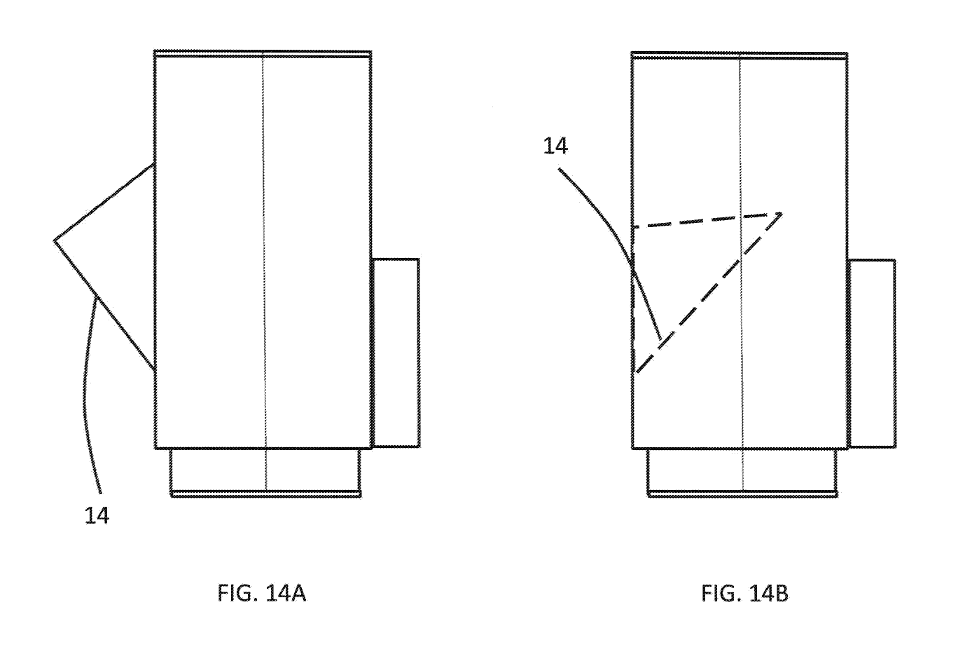

In the case where a planting medium is used, the planting medium can be held within a container or basket 62 which fits within the plant supporting surface and hangs into the first inner volume of the growing module 10 (see FIG. 15) to enable a user to readily remove a plant from the module for transplanting or exchange. In this case, the nutrient solution will generally cascade through and around the exposed root/medium system, ensuring nutrient solution is delivered to the roots of the plant. Alternatively, the planting medium may be “stuffed” into the first inner volume of the growing module 10 without the use of a container or basket. In this case, the nutrient solution generally drains through the planting medium and into any subsequent growing modules 10 that are connected within the modular planting system. If no planting medium is used, the nutrient solution cascades down and “rains” onto the exposed plant roots hanging in the first inner volume of the growth module 10.

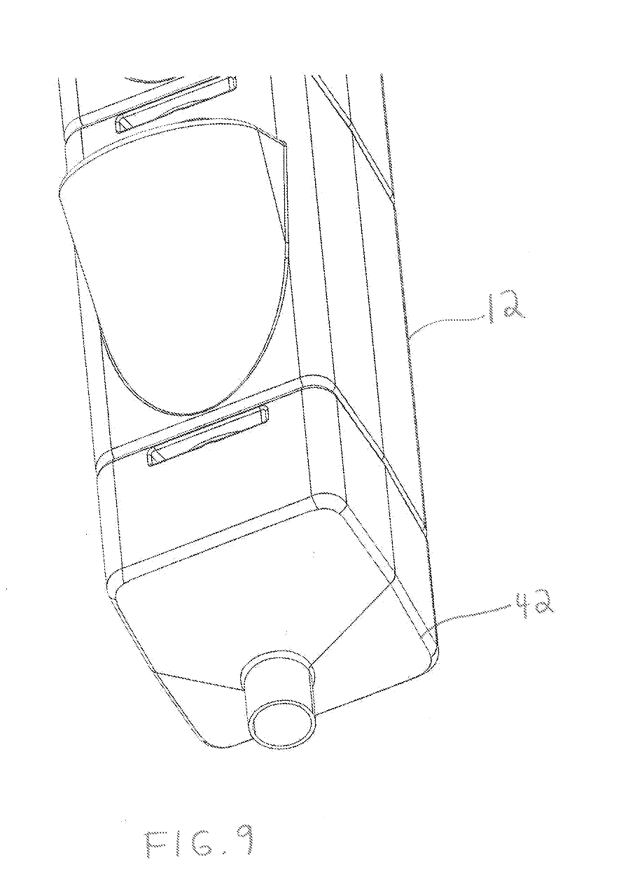

As shown in FIG. 9 and FIG. 13, a collection funnel 42 can be attached to the second (lower) end 18 of the growing chamber 12 to allow for the nutrient solution to be removed from the bottom-most growing module. The collection funnel 42 receives the nutrient solution that has flowed and cascaded through the modular planting system 46. The collection funnel can be connected via a transfer hose 48 which transfers the nutrient solution away from the bottommost growing modules of the modular planting system to the holding tank where it is pumped again to the top of the modular planting system and re-enters the first opening of the top-most growing module to complete a single cycle. As known to those skilled in the art, additional nutrients may be added to the nutrient water at any point to replenish the nutrient solution.

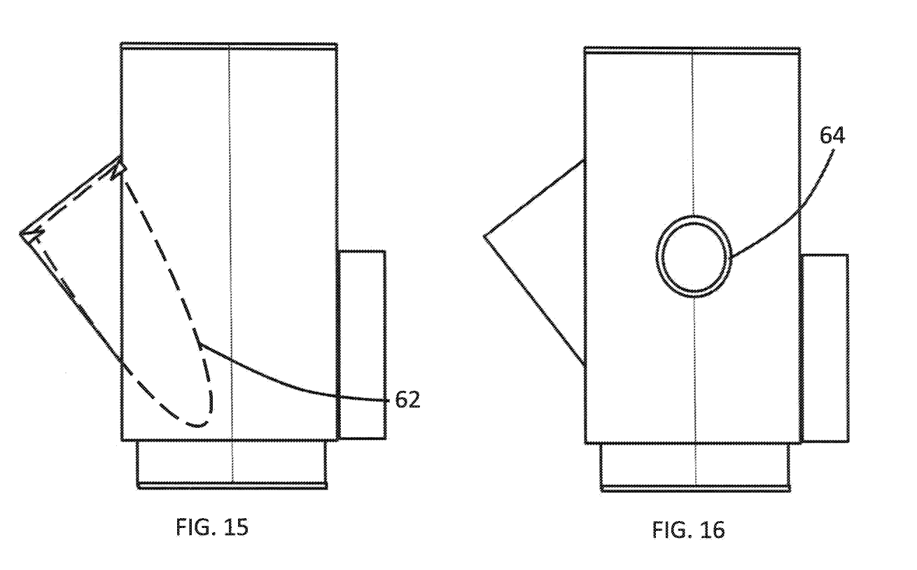

In another embodiment, the growing chamber 12 includes side connectors 64 for attaching adjacent growing modules for lateral attachment (see FIG. 16).The attachment means can be any suitable connection means including hooks, brackets, adhesives or friction connectors such as Velcro™ or other suitable materials. Lateral attachment and vertical attachment can be prepared in any combination with any number of growing modules to produce a planting system adapted to virtually any shape and size of space. This can be useful for aligning the planting system along an edge such as on a balcony, in the corner of a building or room, hanging from a fixture etc.

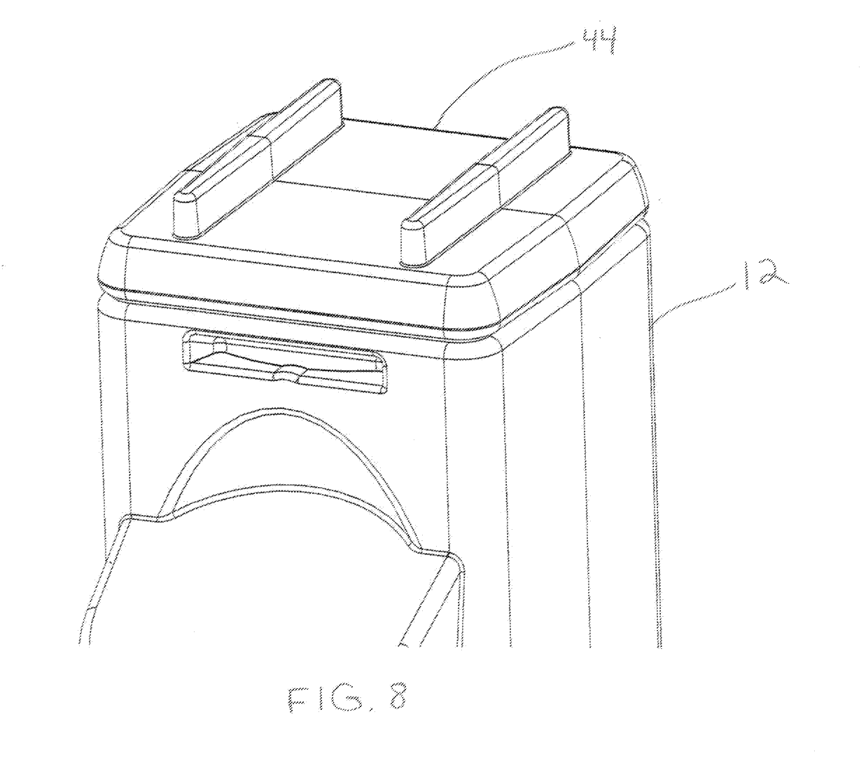

In another embodiment, as shown in FIG. 8 and FIG. 13, a removable cap 44 is attached to the top of the planting system by an insert-and-twist engagement with the detents 38 and 40 at the first end 16 of the top-most growing chamber to provide a cover at the top of the planting system. The top cap can reduce fluid evaporation from the system and/or connection to the nutrient fluid system.

Manufacture

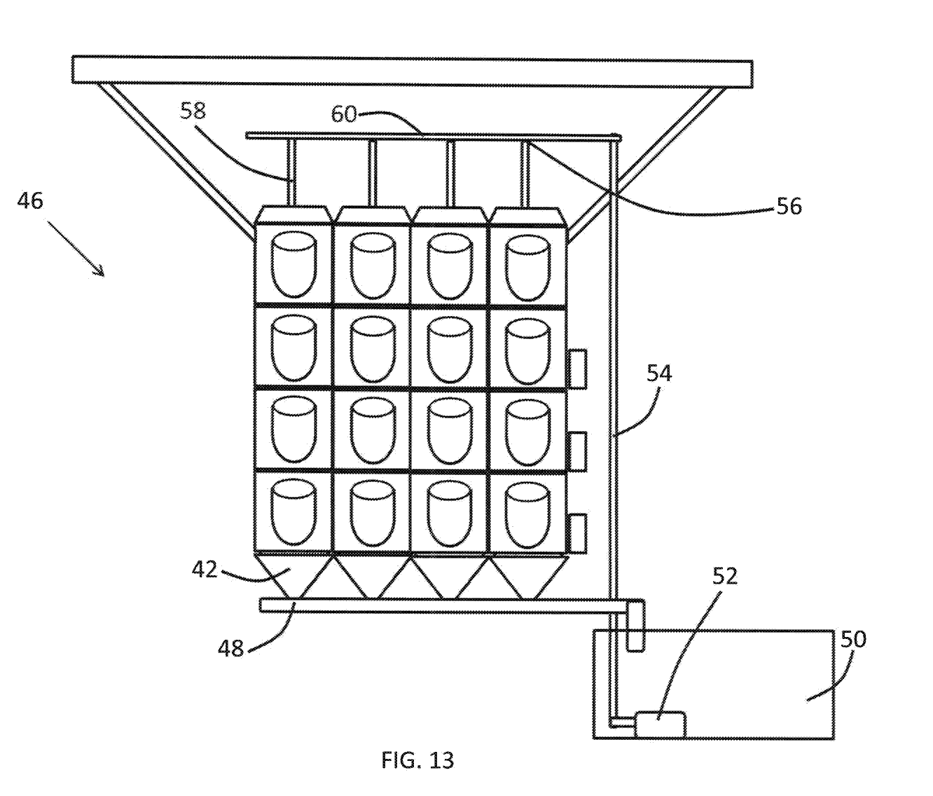

The growing modules can be formed by many known manufacturing techniques such as injection molding or blow molding to form a unitary structure, and can be made from any moldable water-proof material. The removable cap 44 and dripper 42 can also be formed by injection molding. Suitable materials for injection molding include thermoplastics such as ABS (Acrylanitrile Butadiene Styrene), ABS-Polycarbonate Alloy, Acetal and Polyacetal-POM (Polyoxymethylene), PMMA (Poly(Methyl Methacrylate)), Acrylics, Nylons, PBT (Polybutylene Terepthalate), Polyesters, Polyester LCPs (Liquid Crystal Polymers), PP (Polypropylene), PC(Polycarbonate), Polyimides, PPS (Polyphenylene Sulfide), Polysulfones, Cellulosics, EVA (Ethylene Vinyl Acetate), Fluoroplastics, EPP (Explanded Polypropylene), PEEK (Polyether Ether Ketone), PB-1 (Polybutene-1), Polyesters, HDPE (High Density Polyethylene), LDPE (Low Density Polyehtylene), PPO (Polyehthylene Oxide), Modified PPO, PPS (Polyphenylene Sulphide), PMP (Polymethylpentene), HIPS (High Impact Polystyrene), PVC (polyvinyl chloride), SAN (Styrene Acrylonitrile), and Acrylonitrile Styrene Acrylate. Polymer Thermosets can also be used including allylics, alkyds, epoxies, furan, melamines, phenolics, polyurethane cast elastomers, unsaturated polyester and vinyl esters. Preferably, the overall modular planting system is lightweight and can be easily transported in either the assembled modular state or by packing the individual growing modules. In the latter case, in one embodiment, the plant supporting surface 14 is sufficiently pliable to enable it to be collapsed into the first inner volume of the growing module 10 for easy transport and packing. FIG. 14a shows the plant supporting surface 14 in an extended position and FIG. 14b shows the plant supporting surface 14 in a collapsed or retracted position.

In another embodiment, and as mentioned above, the plant may be inserted into a suitable basket or containing a planting medium as noted above to secure the plant during the growing process and to assist in aeration of the roots (see FIG. 15). The basket 62 can be inserted into and subsequently lifted out at any point during growing and planted in conventional soil in the garden. In this scenario, the planter can start the growing process using the planting system and continue the later stages of growing in soil. A planter may wish to sell his or her plants commercially in potted soil for aesthetic purposes while using the modular planting system in the initial stages to ensure healthy and full growing of the plants.

The planting system may be supported by a variety of attachment means including hooks, loops, clamps or tie-straps to secure and/or stabilize the system in a particular configuration. The planting system may also be supported by a free-standing frame or simply leaned against a wall or suitable structure. The attachment means may be integrated into the individual unitary growing modules or attached post-production.

FIG. 13 shows an assembled modular planting system 46 in which the bottom-most growing modules are connected to collection funnels 42 and to a hose 48 for delivery of the nutrient solution to a holding tank 50. In the holding tank 50, a drive pump 52 pumps the nutrient solution up and long the side of the modular planting system 46 through suitable tubing 54. Upon reaching the top of the modular planting system the nutrient solution is directed laterally along the top of the modular planting system via a bend or connection in the hose 54. Spaced holes 56 are provided for directing the nutrient solution to the appropriate top-most growing module. Feed lines 58 extend from the lateral water hose 60 into the first opening of the top-most modules. In one embodiment, a small hole is configured in the top-most module causing the incoming nutrient water to fall with a rain drop effect. As the water cascades down the growing chambers, the solution splashes and flows over the plant root system as discussed above. At the bottom, the collection funnel 42 collects the water into a return line 48 which directs the nutrient water to the holding tank 50 to be recirculated.

In further embodiments, growing modules of different sizes and shapes be designed. For example, a growing module can be provided with more than one plant supporting surface on different sides of the module so that plants can extend from different surfaces of a module. For example, corner modules can be created to enable a user to build a wall of modules without an exposed plastic surface. Similarly, modules can be created in which the plant supporting surface extends from both the front or rear surfaces of the module or all sides of the module. Further still, the growing module is not limited by the shape of the growing module and other shaped growing modules can be formed having generally triangular or round surfaces for example. In further embodiments, growing modules having different shapes and/or sizes can be configured to one another in order to create aesthetically unique forms of assembled systems. For example, a larger base module could be configured with progressively smaller upper modules to create an inwardly tapering system. As such, and as understood by those skilled in the art, the system allows for substantial creativity and flexibility in the design of hydroponic growing systems.

Further still, the system may be provided as a kit where one or more growing modules are sold with one or more funnels and caps and/or nutrient circulation systems thereby allowing the grower to assemble a desired system.

1. A growing module for growing plants hydroponically comprising:
at least one growing chamber having a first growing chamber end and a second growing chamber end, the at least one growing chamber defining a first inner volume, the first growing chamber end having a first opening to the first inner volume, and the second growing chamber end having a second opening to the first inner volume;
at least one plant supporting surface extending outwardly from the at least one growing chamber, the at least one plant supporting surface defining a second inner volume interconnected with the first inner volume for supporting a plant within both the first and second inner volumes; and
the first growing chamber end and second growing chamber end having connection means for interconnecting a plurality of growing modules.

2. The growing module as in claim 1 wherein the at least one plant supporting surface includes supports for engagement with a container fitted within the second inner volume, the container for supporting planting medium.

3. The growing module as in claim 1 wherein the at least one plant supporting surface is movably connected to the at least one growing chamber for moving the at least one plant supporting surface between a retracted position within the first inner volume, and an extended position extending the at least one plant supporting surface outwardly from the growing module.

4. The growing module as in claim 1, wherein the at least one growing chamber includes lateral connectors integrated with the at least one growing chamber, enabling lateral coupling of the growing module to at least one adjacent growing module.

5. The growing module as in claim 1 further comprising a collection funnel for connecting the second growing chamber end to a nutrient collection system.

6. The growing module as in claim 1 further comprising a removable cap for coupling to the first growing chamber end.

7. The growing module as in claim 1 wherein the connection means includes securing lips for rotatable engagement with the second growing chamber end of a vertically adjacent growing module.

8. The growing module as in claim 1, wherein the connection means includes snaps for frictional engagement with a vertically adjacent growing module.

9. The growing module as in claim 1 further comprising a flow restriction device within the first inner volume for restricting the flow of nutrient water through the first inner volume.

10. The growing module as in claim 1, wherein the growing chamber includes at least two plant supporting surfaces integrated to the growing chamber.

11. The growing module as in claim 2 wherein the at least one plant supporting surface is movably connected to the at least one growing chamber for moving the at least one plant supporting surface between a retracted position within the first inner volume, and an extended position extending the at least one plant supporting surface outwardly from the growing module.

12. The growing module as in claim 11, wherein the at least one growing chamber includes lateral connectors integrated with the at least one growing chamber, enabling lateral coupling of the growing module to at least one adjacent growing module.

13. The growing module as in claim 12, further comprising a collection funnel for connecting the second growing chamber end to a nutrient collection system.

14. The growing module as in claim 13 further comprising a removable cap for coupling to the first growing chamber end.

15. The growing module as in claim 14 wherein the connection means includes securing lips for rotatable engagement with the second growing chamber end of a vertically adjacent growing module.

16. The growing module as in claim 15, wherein the connection means includes snaps for frictional engagement with a vertically adjacent growing module.

17. The growing module as in claim 16 further comprising a flow restriction device within the first inner volume for restricting the flow of nutrient water through the first inner volume.

18. The growing module as in claim 17, wherein the growing chamber includes at least two plant supporting surfaces integrated to the growing chamber.

19. A growing module kit for growing plants hydroponically comprising:
at least one growing chamber, the at least one growing chamber having a first growing chamber end and a second growing chamber end, the at least one growing chamber defining a first inner volume, the first growing chamber end having a first opening to the first inner volume, and the second growing chamber end having a second opening to the first inner volume;
at least one plant supporting surface extending outwardly from the at least one growing chamber, the at least one plant supporting surface defining a second inner volume interconnected with the first inner volume for supporting a plant within both the first and second inner volumes; and
the first growing chamber end and second growing chamber end having connection means for interconnecting a plurality of growing modules;
at least one collection funnel for connecting a second growing chamber end to a nutrient collection system; and,
at least one removable cap for coupling to a first growing chamber end.
